(19) United States
(12) Patent Application Publication
(10) Pub. No.: US 2016/0061145 A1
(43) Pub. Date: Mar. 3, 2016

(54) Hybrid Flow Control Method

(71) Applicants: Rajan Kumar, Tallahassee, FL (US); Farrukh Alvi, Tallahassee, FL (US)

(72) Inventors: Rajan Kumar, Tallahassee, FL (US); Farrukh Alvi, Tallahassee, FL (US)

(21) Appl. No.: 14/244,880

(22) Filed: Apr. 3, 2014

Related U.S. Application Data
(60) Provisional application No. 61/807,930, filed on Apr. 3, 2013.

(51) Int. Cl. F02K 1/34; F02K 1/82

(52) U.S. Cl. CPC F02K 1/34; F02K 1/82

(57) ABSTRACT

A system for controlling flow unsteadiness and noise reduction. One or more microjets are placed around the periphery of a jet nozzle in conjunction with a porous surface acting as the impingement surface. As an aircraft is taking off or landing, vertically, the microjets are activated to inject a stream of high-velocity fluid into the shear layer of the main jet at an angle from the main jet centerline. The microjets disrupt the feedback phenomenon, reducing the resonant-dominated aspect of the flow while the porous surface breaks up the coherence of the jet and reduces the broadband noise of the flow.

### CROSS-REFERENCES TO RELATED APPLICATIONS

This non-provisional patent application claims the benefit of an earlier-filed provisional patent application. The provisional application was assigned Ser. No. 61/807,930. It was filed on Apr. 3, 2013.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

The invention relates to the field of flow control in a fluid. More specifically, the invention comprises the use of properly placed microjets coupled with a porous impingement surface to control flow unsteadiness in the flow field of a jet impinging on a surface.

2. Description of Related Art

The impingement of a jet of fluid on a surface is a commonly occurring phenomenon. It takes place in the context of cooling electronics, the launching of a rocket or space shuttle, a fighter jet taking off of an aircraft carrier (using a blast deflector), a short/vertical take-off and landing (S/VTOL) aircraft in vertical hover, as well as other situations. This invention focuses on flow control of such a flow field. More particularly, the focus is on large fluidic jets impinging on surfaces such as in the case of a rocket, fighter jet on an aircraft carrier, or S/VTOL aircraft.

An S/VTOL aircraft in hover or a fighter aircraft taking off from an aircraft carrier creates a complicated flow field. The flow field is complicated due to the high velocity of the jet issuing from the aircraft coupled with the interaction of the jet with a surface. This interaction is highly unsteady, especially in the S/VTOL hover configuration. FIG. 1 shows a schematic of a prior art S/VTOL aircraft in hover. While in hover, aircraft 10 is typically a short distance from surface 16. Main jet nozzle 12 issues a jet of fluid downward. This jet of fluid is the main jet flow 14. Main jet flow 14 impinges upon surface 16 during the take-off, landing, and hover of aircraft 10. As indicated by the arrows in the figure, main jet flow 14 acts downward on surface 16, which lifts aircraft 10 in the upward direction.

The nature of the flow field created by an aircraft in hover creates multiple adverse effects, which include high noise levels, unsteady acoustic loads, sonic fatigue on the aircraft and surrounding structures, ground erosion, ingestion of hot gases into the engine nacelle and lift loss of the aircraft. This is also problematic in the case of a plane taking off from an aircraft carrier. As an aircraft takes off from the deck, a blast deflector is used to redirect the high energy jet issuing from the jet nozzle. The primary concern during takeoff from an aircraft carrier deck is the high noise levels generated by the impingement of the main fluid jet on the blast deflector. FIG. 2 shows aircraft 10 taking off from aircraft carrier deck 21. As main jet flow 14 collides with blast deflector 22, jet flow 14 is redirected upwards as demonstrated by the arrows. While this does protect workers on the deck from the blast of the jet, the noise levels generated are exceedingly high. These noise levels are extremely detrimental and cause a serious health concern for personnel working on the deck of the carrier.

Due to the adverse effects associated with a jet impinging on a surface, such as the ground or a blast deflector, this subject has been largely investigated. Studies have established a basic understanding of the flow field, and in turn, discovered the source of the noise and unsteadiness. To those familiar with the art the cause of this unsteadiness is referred to as the feedback phenomenon. The feedback phenomenon is a loop that starts at the nozzle exit of the jet then progresses to the ground and back. This phenomenon creates strong acoustic waves which create a resonance that is the source of the high noise levels. In order to decrease unsteadiness and reduce noise, this feedback loop must be disrupted.

The prior art includes several passive and active approaches used in order to disrupt the feedback phenomenon. Some passive methods include insertion of two perpendicular wires into the flow field of the jet, tabs at the nozzle exit that protrude into the jet, and insertion of a plate slightly downstream of the nozzle exit. A few active forms of flow control and noise reduction include suction at the nozzle exit to create counter-flow, high speed co-flow issued near the nozzle exit, and the injection of microjets at the nozzle exit. Thus, the prior art shows that in order to reduce noise, the feedback loop must be disrupted. In addition, the prior art shows that there is an actual demand for reducing the noise and controlling the flow of an impinging jet.

Previous methods have been successful in flow control and noise reduction, but the prior attempts at active control require a much higher percentage of the jet momentum than the present system. In addition to less momentum required, the current system is both more effective than other methods proposed in prior art and more effective than the sum of the two individual methods presented here. Furthermore, the current inventive system is effective over a wider range of operating conditions than shown in prior art.

### BRIEF SUMMARY OF THE PRESENT INVENTION

The present invention comprises a hybrid flow control system and method used to reduce unsteadiness produced when a jet of fluid flow impinges upon a surface. The hybrid system comprises providing an array of equally spaced microjets placed around the periphery of the nozzle exit that issue fluid into the main jet flow. The fluid can be compressible or incompressible (for the main jet and microjet flow). In the case of a Vertical/Short-Takeoff and Landing aircraft, the microjets can be actuated during takeoff or landing by a sensor or a crewmember. A similar approach can be employed during takeoff from an aircraft carrier deck.

In addition to microjet injection, the hybrid flow control system includes a porous surface for which the fluid jet from an aircraft can impinge upon. In the case of takeoff from an aircraft carrier, the porous surface can be installed within the blast deflectors on the deck. For a V/STOL aircraft (which already requires a specific landing area), the porous surface is installed within the landing surface already created for the aircraft.

### BRIEF DESCRIPTION OF THE SEVERAL VIEWS OF THE DRAWINGS

FIG. 1 is a schematic view, showing a prior art aircraft beginning to take off vertically.

FIG. 2 is a schematic view, showing a prior art aircraft taking off using a blast deflector.

FIG. 3 is a schematic view, showing the current invention implemented in an S/VTOL aircraft application.

FIG. 4 is schematic view, showing the current invention implemented in a blast deflector application.

FIG. 5 is a perspective view, showing a model used in experimentation for the current invention.

FIG. 6 is an elevation view, showing the placement of the microjets on the microjet housing with regard to the main jet exit.

FIG. 7 is an elevation view, showing a simple schematic of the flow directions and parts of the current patent.

FIG. 8 is an elevation view, showing the flow unsteadiness and acoustic waves associated with a jet impinging on a normal surface as seen in prior art.

FIG. 9 is an elevation view, showing the effect of injecting microjets into the main jet flow at the nozzle exit as described in prior art.

FIG. 10 is an elevation view, showing the effect of the hybrid control on a jet impinging on a normal surface.

REFERENCE NUMERALS IN THE DRAWINGS

| | | | |
|---|---|---|---|
| 10 | aircraft | 12 | main jet nozzle |
| 14 | main jet flow | 16 | surface |
| 18 | microjet housing | 20 | porous surface |
| 21 | aircraft carrier deck | 22 | blast deflector |
| 24 | microjets | 26 | main jet nozzle exit |
| 28 | microjet nozzle exit | 30 | microjet flow |
| 32 | main jet centerline | 34 | stagnation bubble |
| 36 | large-scale vortical structure | 38 | acoustic wave |
| 40 | normal surface | | |

### DETAILED DESCRIPTION OF THE INVENTION

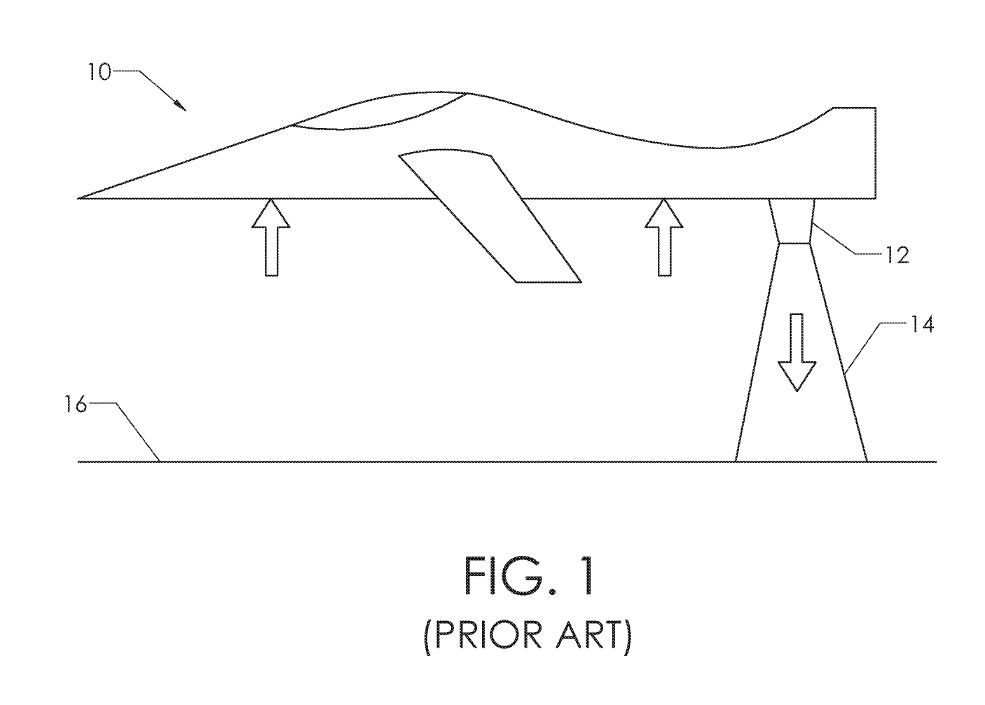

FIG. 1 shows a schematic of a prior art S/VTOL aircraft in hover. As discussed in the preceding text, main jet flow 14 issues from main jet nozzle 12. Main jet flow 14 impinges on surface 16, which creates lift. The forces created are indicated by the arrows in the figure. The reader should note that aircraft 10 can be taking off landing or simply hovering above surface 16. Aircraft 10 takes off when main jet flow 14 acts on surface 16 with enough thrust to lift aircraft 10 from surface 16.

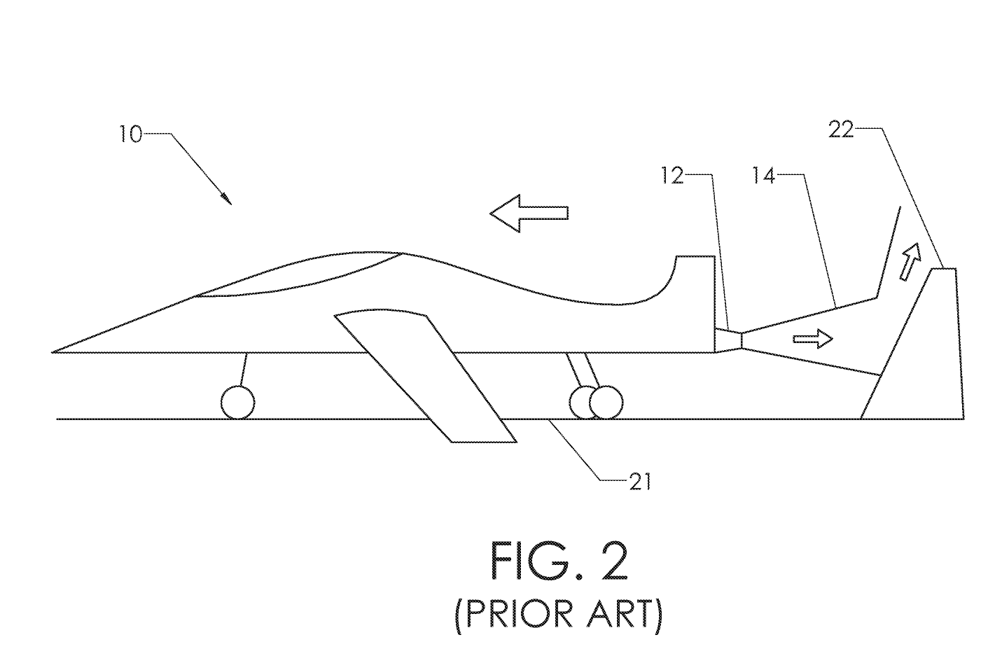

FIG. 2 shows aircraft 10 taking off from aircraft carrier deck 21. Similar to FIG. 1, the reader can see that main jet 14 impinges upon a surface. In this case, the surface is blast deflector 22. As demonstrated by the arrows within main jet 14, blast deflector 22 redirects the flow up and away from any equipment or personnel that may be on deck 21.

A V/STOL aircraft in hover and a fighter jet taking off from an aircraft carrier (using a blast deflector) have been highly studied topics due to the immediate harm caused by the ensuing flow field. As discussed previously, the unsteady flow that occurs due to a jet impinging on a surface is detrimental in many aspects. Because of this, many methods for reducing noise and unsteadiness have been explored as seen in the previous section. The present invention uses a hybrid control approach to reduce this unsteadiness, thereby attenuating the detrimental effects created by the flow of the jet.

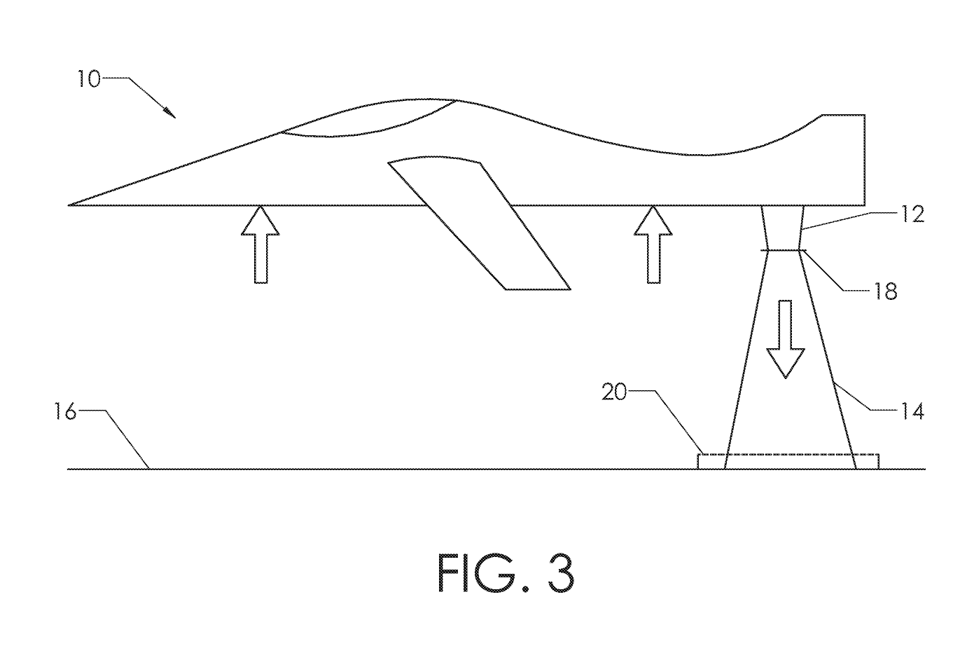

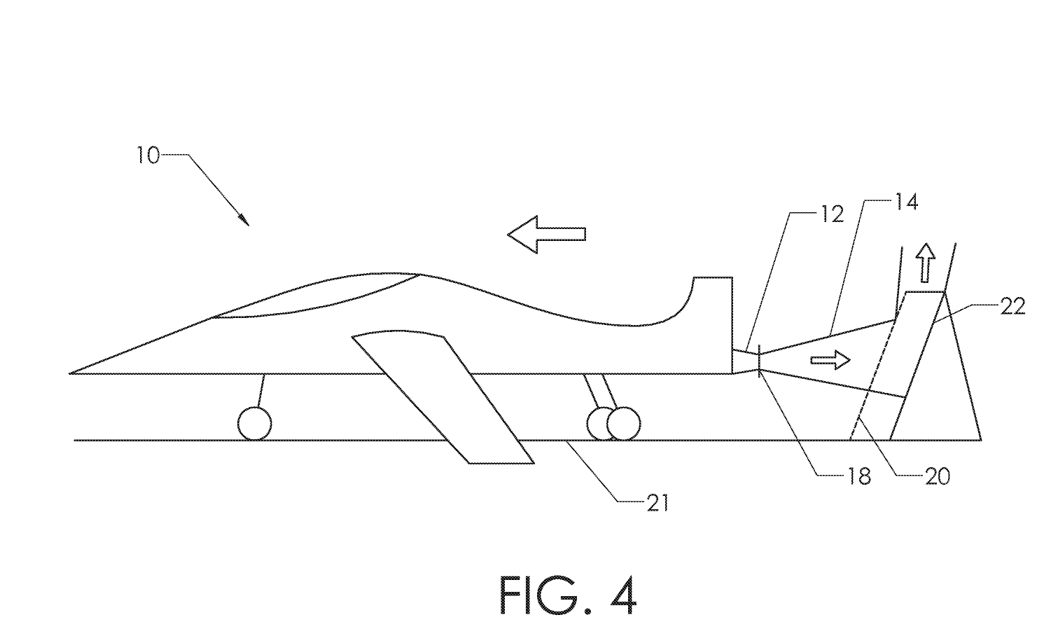

FIGS. 3 and 4 illustrate applications of the current inventive system. FIG. 3 shows aircraft 10 hovering above surface 16. Main jet flow 14 of the aircraft is not impinging upon surface 16 as it is in FIG. 1, it is impinging upon porous surface 20. Also, main jet nozzle 12 preferably has microjet housing 18 attached to it. Preferably, microjet housing 18 is used to house microjets 24, which is discussed further in the following text. As is further described herein, microjet housing 18 is one of many methods that can be used to attach microjets 24 to the main jet nozzle 12. For example, microjets 24 can be attached directly to the main jet nozzle 12 by a series of tubes, without microjet housing 18.

FIG. 4 is a schematic view, showing another application of the current invention. Aircraft 10 is taking off from aircraft carrier deck 21 in the figure. The motion of aircraft 10 and main jet 14 is indicated by the arrows, where the flow of the jet 14 acts on the blast deflector 22 in order to propel aircraft 10 forward. In this view, main jet nozzle 12 has been modified to encompass microjet housing 18 which preferably incorporates microjets 24. In a preferred embodiment of the invention, porous surface 20 is installed on blast deflector 22. As will be further described herein, the operation of microjets 24 and porous surface 20 act in conjunction to reduce unsteadiness and noise caused by main jet 14 impinging upon a surface.

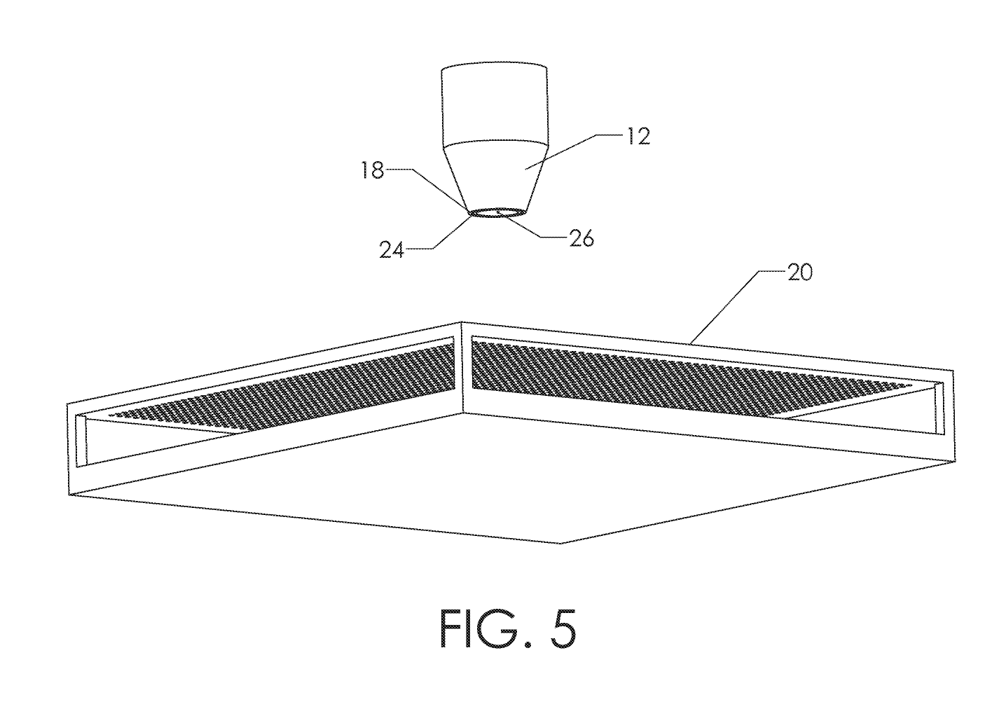

A preferred embodiment of the present invention is shown in FIG. 5. This perspective view shows main jet nozzle exit 26 from which main jet flow 14 issues downward (shown in the previous figures). Main jet flow 14 issues downward and impinges upon porous surface 20. There are many ways in which air can be supplied to microjets 24. These methods may include an air compressor, compressed air tanks, bleed air from the main jet of the aircraft or any other number of methods. The preferred embodiment of the inventive system uses bleed air from the aircraft to pressurized microjets 24. The reader should note that the mass flow of microjets 24 is less than one percent of the mass flow of main jet 14.

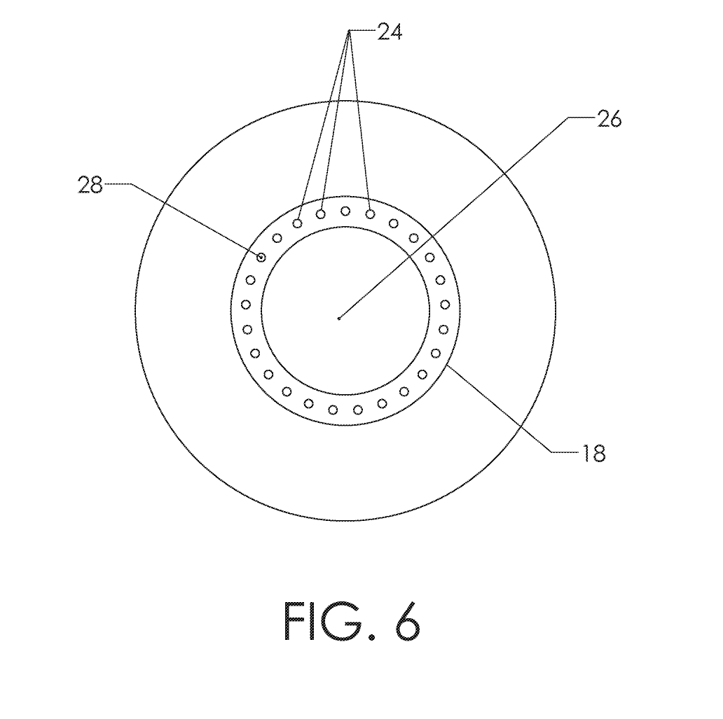

FIG. 6 shows an elevation view of a typical aircraft nozzle with microjet housing 18 attached. Main jet nozzle exit 26 is centrally located. In a preferred embodiment of the present invention, 16 equally-spaced, 400 micron diameter microjet nozzle exits 28 are placed around the periphery of main jet nozzle exit 28. The reader will note that microjets 24 are implemented into microjet housing 18. However, there are multiple configurations in which microjets 24 can be implemented so the reader should not restrict the current invention to such an implementation.

Although the microjet configuration is illustrated mounted within microjet housing 18, it is possible to inject microjets without the presence of microjet housing 18. For example individual tubes could protrude (possibly able to retract) to inject flow at main jet nozzle exit 26. The configuration shown is simply one possibility of many and should not be taken as the ideal embodiment.

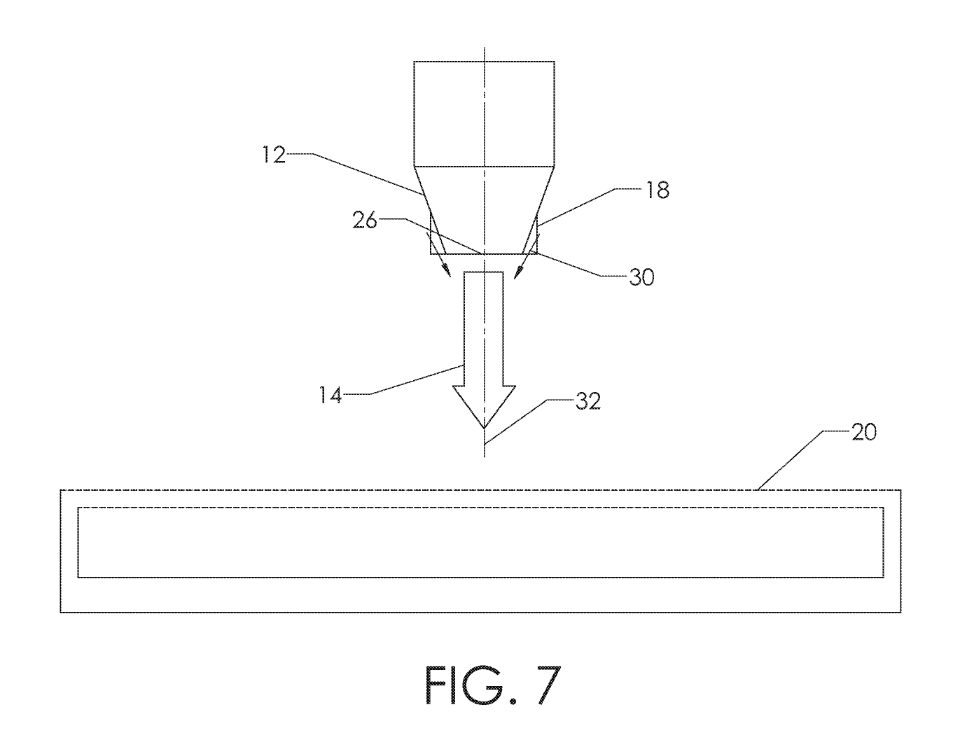

FIG. 7 shows a schematic of the flow direction of main jet flow 14 and microjet flow 30. Main jet flow 14 is represented by the large, central arrow, and microjet flow 30 is represented by smaller arrows. Those familiar in the art will know that flow of main jet 14 travels downward (in the current view), issuing from top to bottom in the current view. However, microjet flow 30 travels into the flow field at an optimized angle from main jet centerline 32. In order to be successful, microjet flow 30 must penetrate main jet flow 14. In doing so, counter-rotating, streamwise vortices are formed. This is the mechanism for which microjet flow 30 disrupts the feedback phenomenon. Briefly, streamwise vortices thicken the shear layer of the jet. Thus, the jet is less susceptible to disturbances due to the thickened shear layer.

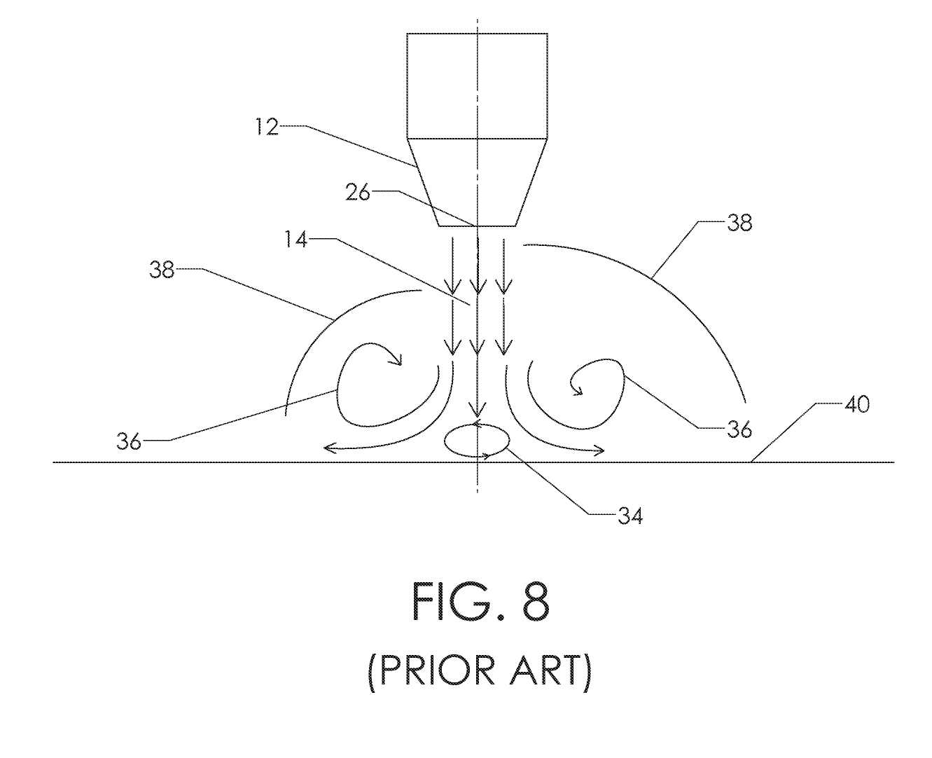

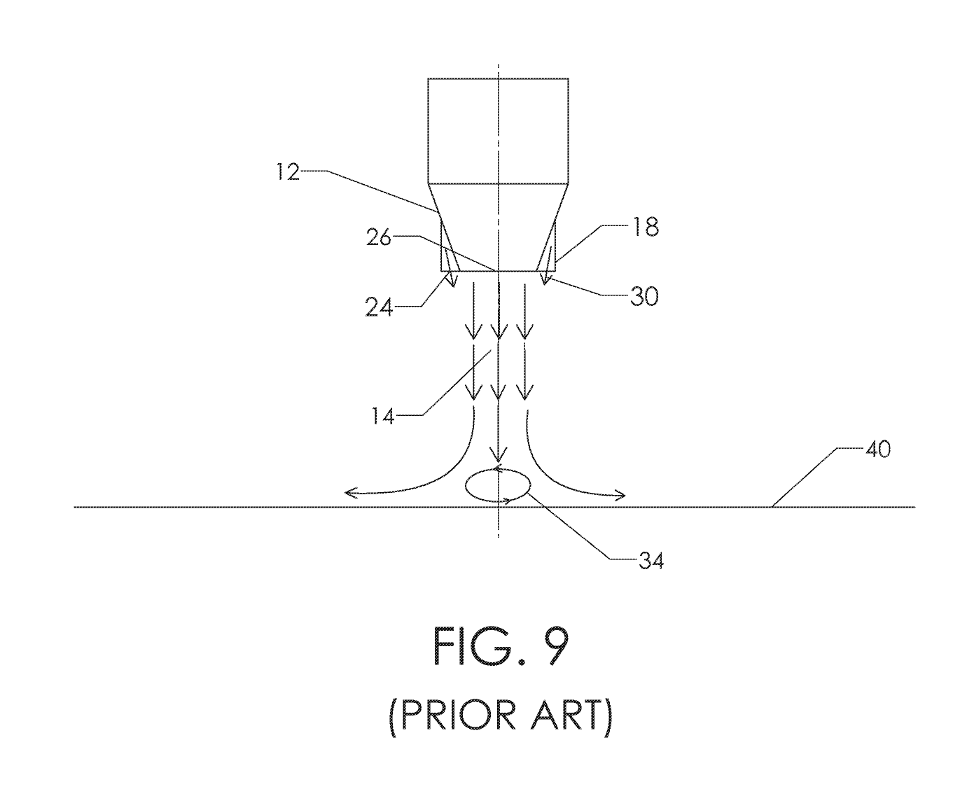

In order to demonstrate the beneficial effects of the present invention, prior art flow fields are illustrated in FIGS. 8 and 9. FIG. 8 shows a schematic of a prior art flow field of a jet impinging upon normal surface 40. The reader should not that this is a schematic of the flow field without any flow control implemented. Fluid flow from main jet 14 issues downward in the current view. As main jet flow 14 approaches normal surface 40, main jet flow 14 must change direction in order to accommodate the obstacle. The figure shows the flow rapidly changing from traveling in a direction parallel to the jet centerline 32 to a direction perpendicular to the jet centerline 32. Due to the high velocity of main jet flow 14 and the close proximity of the jet to normal surface 40 it is impinging upon, this change in direction is accompanied by other factors that complicate the flow field even further.

As those skilled in the art will recall, the sudden impingement of main jet flow 14 on normal surface 40 creates stagnation bubble 34. Stagnation bubble 34 is a small region of recirculating flow that occurs due to the sudden impingement of the high velocity fluid from main jet 14 onto a surface 40. A small portion of the fluid cannot change direction quickly enough causing it to stay trapped near the stagnation point of the flow. The fluid that is able to change direction travels along the wall at a speed significantly lower than the speed of main jet 14. Those familiar with the art will know that the portion of low speed flow traveling along normal surface 40 is referred to as a wall jet in the literature.

Impingement of jet flow 14 upon normal surface 40 also creates unsteadiness. FIG. 8 depicts flow unsteadiness in the form of large-scale vortical structures 36. These vortices 36 are the main source of flow unsteadiness and noise production in the case of jet 14 impinging upon normal surface 40. When vortical structures 36 impinge upon normal surface 40, strong acoustic waves 38 are created. Acoustic waves 38 travel upstream until they reach the nozzle exit 26 is reached. Upon striking nozzle exit 26, acoustic waves 38 create a disturbance that propagates down through the shear layer of the jet. The disturbance grows as it moves downstream until it becomes large vortical structure 36 (which started the disturbance). This phenomenon is known as the feedback loop, and it is known, by those familiar with the art, to be the source of much of the noise and unsteadiness created by an impinging jet.

As discussed previously, it has been the goal of researchers in the art to disrupt the feedback loop in order to reduce unsteadiness and noise. One of the most successful methods of disrupting this loop is microjet injection at the nozzle exit. While the setup for this method has been discussed, the effect of microjet injection has not. FIG. 9 shows a prior art schematic of the fluid flow of main jet 14 and microjets 30. It is important to note that microjet flow 30 enters the stream of the main jet 14 at an optimized angle to jet centerline 32, as shown in FIG. 9. Injection of microjet fluid 30 has a significant impact on the flow field while using a relatively small amount of momentum (about 0.5% of the main jet momentum).

Also shown in FIG. 9 is a schematic of the effect of microjet injection 30 on the flow field of a jet 14 impinging upon normal surface 40. Recall that in FIG. 8, there are large vortices 36 near impingement surface 40 in the shear layer of the jet. However, in FIG. 9 with the addition of microjet flow 30 at the main jet nozzle exit 26, those vortices are significantly reduced in magnitude. Also, recall that FIG. 8 shows strong acoustic waves 38 in the ambient air near jet 14 traveling upstream, but with microjet injection 30 those waves 38 are eliminated. Injection of flow using microjets disrupts the feedback loop and therefore attenuates the noise produced by an impinging jet.

The injection of fluid using microjets at the nozzle exit demonstrates a control-on-demand concept. The microjets are actuated only during take-off or landing situations. Thus, using energy to reduce noise and control the main jet flow only when it is required. This could be done manually or using properly placed sensors that would activate the injection of the microjets when necessary.

Microjet injection has been shown to work for multiple operating parameters and conditions, but still has limitations. Although, the injection of microjets is effective at reducing noise caused by the jet impinging on a surface, it still can be improved. Microjet control disrupts the feedback loop so the noise attenuation is only relevant to the noise created by the feedback loop. While that is a very large portion of the noise, it is not the only source of noise. The feedback loop is the source of an impinging jet's highly resonant nature. The noise spectra show a sharp peak that is greatly reduced with microjet injection. Unfortunately, microjet injection does not provide much reduction in the broadband noise.

In order to diminish the broadband noise, a porous material has been used in replacement of the typical solid impingement surface. The results of this have been successful in reducing the broadband noise and the overall sound levels. As this is a passive method of control, it is very simple to implement and once implemented, there would be minimal maintenance required. Installing grates to landing areas for S/VTOL aircraft and blast deflectors could be done quickly and cost-effectively without any impact on conventional take-off and landing aircraft.

The present invention uses microjet injection coupled with the use of a porous surface to create a hybrid control method. This approach combines a method that focuses on reducing the resonance of the flow field with one that focuses on reducing the broadband noise of the flow field. While both approaches are effective in noise reduction, it has been shown that the combination of the two methods is more effective than simply the additive effect of the two techniques.

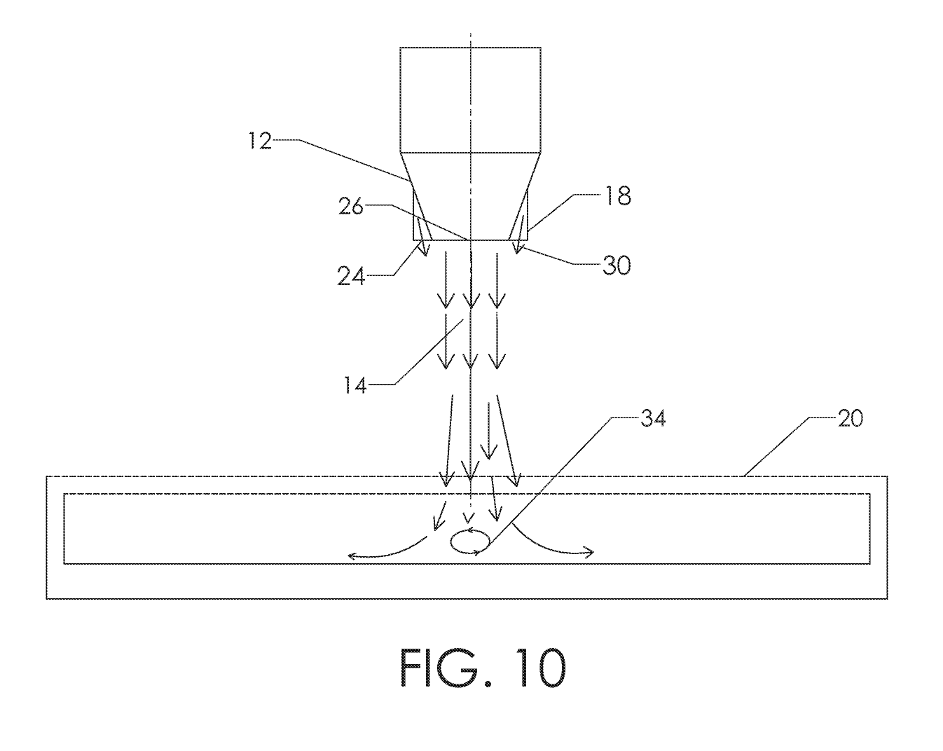

FIG. 10 shows a schematic of the effect of hybrid control on the flow field of an impinging jet. The appearance of the hybrid control method visually, is similar to that of the control method using only microjet injection. Again, the flow of main jet 14, issued from main jet nozzle 12, can be seen with the flow of the microjets 30 entering the flow at an angle to main jet centerline 32. FIG. 10 shows that there is still a small stagnation bubble 34 on normal surface 40, but it is smaller than stagnation bubble 34 seen in FIG. 9 when only microjet injection is used. Porous surface 20, in essence, breaks up the coherence of the jet, which reduces the broadband noise.

Upon further analysis of FIG. 10, the reader will realize that the main flow of jet 14 is an area of high pressure while the area outside of the main jet flow has a much lower pressure. Porous surface 20 allows that pressure to equalize more readily, thus breaking up the coherence of main jet flow 14 once it impinges on porous surface 20. Those skilled in the art will agree that breaking up the coherence of main jet 14 reduces broadband noise.

The result of the hybrid flow control method is a reduction in noise both in the broadband and narrowband. Each piece of the hybrid control works separately to reduce the total noise of the system. By using two methods, one passive on the ground and one active at the nozzle exit, the current invention reduces noise and unsteadiness by a factor greater than the additive effect of the two methods.

Although the preceding description contains significant detail, it should be viewed as providing explanations of only some of the possible embodiments of the present invention. Thus, the scope of the invention should be fixed by claims ultimately drafted rather than any specific example given.

1. A hybrid flow control system and method for reducing the production of detrimental effects, such as noise, when a main jet having a main jet flow of a fluid is expelled from a main jet nozzle and impinges on a surface, further comprising:
a. providing an array of microjets attached to said main jet nozzle proximate a nozzle exit;
b. providing a porous surface such that said main jet flow issues downward impinging on said porous surface;
c. expelling said main jet flow from said main jet nozzle;
d. expelling a microjet flow from said array of microjets;
e. wherein said microjet flow penetrates said main jet flow; and
f. allowing said microjet flow and said main jet flow to impinge on said porous surface.

2. The hybrid flow control system and method as recited in claim 1, wherein said array of microjets are attached to said main jet nozzle via a microjet housing.

3. The hybrid flow control system and method as recited in claim 1, wherein said array of microjets are equally spaced around said main jet nozzle exit.

4. The hybrid flow control system and method as recited in claim 1, further comprising the step of providing an air compressor fluidly attached to said array of microjets.

5. The hybrid flow control system and method as recited in claim 1, further comprising the step of providing a compressed air tank fluidly attached to said array of microjets.

6. The hybrid flow control system and method as recited in claim 1, further comprising the step of fluidly attaching said array of microjets to said main jet.

7. The hybrid flow control system and method as recited in claim 1, wherein said porous surface is included on a blast deflector.

8. The hybrid flow control system and method as recited in claim 1, wherein said porous surface is included on a ground surface.

9. The hybrid flow control system and method as recited in claim 1, wherein said main jet is comprised of a compressible fluid.

10. The hybrid flow control system and method as recited in claim 1, wherein said main jet is comprised of an incompressible fluid.

11. A hybrid flow control system and method for expelling a main jet flow from a main jet having a main jet nozzle, further comprising the steps of:
a. providing a series of microjets attached to said main jet nozzle proximate a nozzle exit;
b. expelling said main jet flow from said main jet nozzle;
c. expelling a microjet flow from said series of microjets;
d. wherein said microjet flow penetrates said main jet flow at an optimized angle;
e. providing a porous surface such that said main jet flow issues downward impinging on said porous surface; and
f. wherein said microjet flow and said main jet flow impinge on said porous surface.

12. The hybrid flow control system and method as recited in claim 11, wherein said series of microjets are attached to said main jet nozzle via a microjet housing.

13. The hybrid flow control system and method as recited in claim 11, wherein said series of microjets are equally spaced around said main jet nozzle exit.

14. The hybrid flow control system and method as recited in claim 11, further comprising the step of providing an air compressor fluidly attached to said series of microjets.

15. The hybrid flow control system and method as recited in claim 11, further comprising the step of providing a compressed air tank fluidly attached to said series of microjets.

16. The hybrid flow control system and method as recited in claim 11, further comprising the step of fluidly attaching said series of microjets to said main jet.

17. The hybrid flow control system and method as recited in claim 11, wherein said porous surface is included on a blast deflector.

18. The hybrid flow control system and method as recited in claim 11, wherein said porous surface is included on a ground surface.

19. The hybrid flow control system and method as recited in claim 11, wherein said main jet is comprised of a compressible fluid.

20. The hybrid flow control system and method as recited in claim 11, wherein said main jet is comprised of an incompressible fluid.
